(19) United States
(12) Patent Application Publication
(10) Pub. No.: US 2012/0205298 A1
(43) Pub. Date: Aug. 16, 2012

(54) APPARATUS AND METHOD FOR ANALYSING A SECURITY DOCUMENT

(75) Inventors: Ronald Bruce BLAIR, Flower Mound, TX (US); Alexandre Gret, Liebefeld (CH)

(73) Assignee: DE LA RUE INTERNATIONAL LIMITED, Basingstoke (GB)

(21) Appl. No.: 13/456,069

(22) Filed: Apr. 25, 2012

Related U.S. Application Data
(63) Continuation of application No. 12/451,745, filed on Feb. 24, 2010.

(51) Int. Cl. G06K 7/10; B07C 5/342

(52) U.S. Cl. 209/589; 250/271

(57) ABSTRACT

We provide an apparatus and method for analysing a security document using x-rays. A security thread is provided in a security thread region of the document. An x-ray source illuminates the security document and an x-ray detector receives x-rays from the security thread region of the document and generates a corresponding detector response. A processor analyses the detector response and generates an output signal indicative of the structure of a security thread present within the region.

This is a Continuation Application of U.S. application Ser. No. 12/451,745 filed Nov. 30, 2009. The disclosure of the prior application is hereby incorporated by reference herein in its entirety.

### BACKGROUND

The present invention relates to an apparatus and method for analysing a security document, in particular by use of an x-ray technique.

There are now a number of well established techniques for increasing the security of certain types of document. Such “security documents” include banknotes (including paper and plastic currency), bonds, legal documents, identification documents and other documents where the authenticity of the document is extremely important.

Such documents are often provided with one or more overt or covert “security features”, these including specialist inks, optically variable elements, specialist printing techniques and particular substrate materials. One security feature often found in banknotes is that of an embedded thread. In some cases such a thread may be visible on the surface of the banknote, the thread typically having a metallised exposed surface, whereas in some cases the thread is entirely embedded within the banknote and is only normally visible optically under transmitted light conditions. Partially embedded threads which appear to “weave” through the note material are also common, for example in United Kingdom currency.

The presence of a thread which is visible to the naked eye as an overt security feature is difficult to counterfeit. However, many such security threads include a further covert feature in the form of regions of magnetic (this term including magnetisable) material, these materials being hard and soft magnetic materials respectively. The location of such materials is not visible to the naked eye although it is machine readable by the use of a magnetic detector within appropriate document processing apparatus.

The magnetic material in question is usually deposited along the length of the thread during manufacture with the position and dimension of each deposit being in accordance with a code. The code can be related to the type of document, in particular the denomination. Typically this code is repeated many times across the sheets from which the banknotes are cut during production. There normally exists more than one repeat of the code in any particular thread of a banknote, although normally the position of the beginning of any particular “repeat” is not at a fixed distance from the edge of the note.

When in use, a banknote processing apparatus (in this example) is arranged to pass the thread within close proximity of a magnetic read head and a small electrical signal is obtained as each deposit of material passes the magnetic read head. With knowledge of the speed of passage of the banknote past the detector it is then possible to “decode” the magnetic code by analysing the signal received from the read head.

Whilst this technique is difficult to counterfeit without substantial effort, in practical banknote processing apparatus which is usually required to operate at high speeds, it is difficult to effect the reliable reading of the magnetic code. In order to maximise the read signal, the note is often forced firmly against the read head with the use of curved transport paths, rollers or leaf springs. Even then, there may exist a small distance between the read head and the material in the case of embedded threads. The technique therefore entails a number of problems and also is detrimental in that it may cause wear of the banknotes in the thread region. Furthermore, soiling of the notes or extensive creasing makes a good quality magnetic signal very difficult to obtain. This also puts limitations upon the amount of detail that can be placed within the magnetic code due to the low spatial resolution.

### SUMMARY

In accordance with a first aspect of the invention we provide apparatus for analysing a security document containing a security thread in a security thread region, that apparatus comprising an x-ray source adapted to illuminate the security document in the security thread region, an x-ray detector adapted to receive x-rays from the security thread region of the document and to generate a corresponding detector response, and a processor adapted to analyse the detector response and to generate an output signal indicative of the structure of a security thread present within the region.

We have realised that, by using x-rays, the magnetic code upon security document threads can be read with speed and accuracy and without encountering many of the problems inherent with the use of magnetic read heads. X-ray source and detector combinations and arrangements can be used to provide highly detailed spatial information regarding the magnitude and location of the regions of magnetic material forming part of the security threads.

The method performed by the apparatus may be achieved using a stationary document. This might be the case in apparatus where single documents are inspected. Alternatively it might be used in apparatus having a stack of documents for automatic feeding and processing and in which the analysis is performed according to the invention whilst the document is stationary in a feed tray containing the document stack. For example the next document to be fed (either top-most or bottom-most in the stack) may be that which is analysed, the end of the stack comprising the inspection position. Preferably, the apparatus further comprises a transport path for transporting the document through the inspection position wherein the apparatus is arranged such that the x-ray source illuminates the document when in the transport path.

The use of x-rays offers the ability to increase the spatial resolution of the magnetic code, allowing the same information to be provided in a smaller dimension, thereby increasing the number of possible repeats or a longer code per unit length of thread. A further advantage is that it is not necessary to effect contact between the document in question and either or each of the detector and source. This reduces document wear and allows increased document conveyance speeds and a reduction in possible jams.

Thus, the invention finds advantage in that the structure of a thread may be determined, particularly in terms of magnetic materials. The invention can therefore be used with many of the millions of security documents in circulation, such as banknotes.

We have further realised that the structure of the thread that is analysed using the invention is not limited to the use of magnetic materials. It follows from this that non-magnetic materials can be used to embody codes that are embedded as material deposits within a thread. All that is needed is that sufficient x-ray contrast is provided by the presence or absence of such materials according to the particular code. Materials such as non-magnetic forms of various metals or non-metals may be used to achieve this.

The x-ray detector is typically a line scan detector such as a line scan camera. This provides advantages in terms of cost and in reducing the x-ray power used for a given transport path speed. It is however also envisaged as an alternative that an array scan or “imaging” detector may be used which produces two dimensional pixel array x-ray image information. Typically of course an equivalent image may be formed by the combination of line scans from a line scan detector.

An x-ray source providing an area of emitted x-rays in two dimensions may be used either with a line or area detector.

In principle, provided the dimension defining the line of the detector is parallel with that of the thread, a single line scan may be used to obtain x-ray information from points along the entire length of the thread. However, in order to improve the signal to noise ratio and indeed to deal with any skew in the orientation of the documents, it is preferred to obtain multiple line scans even when the line scan direction is parallel with that of the elongation of the thread.

The security document may therefore be fed along the transport path by a leading edge wherein the length of the detector is preferably equal to that of the leading edge and in any case at least that of the repeat length of the magnetic code. This is a preferred arrangement in the case of a “short edge” feed for rectangular documents. The use of a “long edge” feed is also contemplated and in this case the length of the line scan detector may only be needed to encompass a range of possible positions of the thread. In the case of the use of an array scan, such as an imaging detector, the image of the entire document or a part thereof, may be taken and used, regardless of the type of feed (short edge or long edge).

Preferably the x-ray source is located upon an opposite side of the transport path with respect to the x-ray detector so as to provide a transmissive arrangement. Thus the x-ray contrast in such an arrangement is generated by the transmissive arrangement. It is also however envisaged that, assuming the use of appropriate materials which re-emit or fluoresce in the x-ray frequency upon stimulation of x-rays from the source, that a reflective arrangement may be used either as an alternative to or in addition to the transmissive arrangement described. In this case, for the reflective arrangement, the source and detector may be positioned upon a similar side of the transport path. Thus the “sides” of the transport path may be thought of in terms of the opposing planar faces of the security documents in question.

Typically the x-ray source and/or detector are positioned approximately normally to the face of the document as it passes along the transport path, so as to maximise both the received signal and the spatial resolution of the data obtained.

Typically the thread of the security document is provided with one or more regions of magnetic (including magnetisable) material and the apparatus is further adapted to locate the position of the one or more regions of this material. This may be achieved by monitoring the positional variation in intensity of the x-ray data produced by the detector. Typically therefore the apparatus is arranged to generate sufficient x-ray contrast so as to locate the position of the one or more regions of material (magnetic or otherwise).

The data are preferably processed by the “obtained” response from the detector (a detector response), being compared with a predetermined response corresponding to that obtained from an “expected” document such as a genuine document. The comparison may involve the consideration of intensity or contrast thresholds and the number or proportion of pixels which pass such thresholds. Preferably however, the apparatus is adapted to generate an image of the security thread region formed from a number of detector responses generated at different locations for each document.

The processor is therefore preferably adapted to compare the image with one or more predetermined master images. A set of such master images may be provided, in the case of banknotes, for each particular denomination of a currency. Typically four such master images are provided for each denomination, currency type or issue, these relating to possible feed orientations. An image analysis process may be used to make the comparison and, as a result, an output is generated which is dependent upon the result of the image analysis process. This may involve a number of known techniques of image analysis, for identifying features within images. Typically some measure of correspondence between the obtained and predetermined response is produced as a result of the analysis and, provided such correspondence is sufficient, the documents may be determined as being of the same type as that of the corresponding master image.

The apparatus may be used as part of document sorting apparatus for example for rapidly sorting documents according to their type. It may also be used in a document authenticator for sorting genuine documents from counterfeit documents and of course it may be used in apparatus combining sorting and authentication functions. The apparatus finds particular use in banknote processing fields although it will appreciated that it may be used for processing other security documents.

It is envisaged that the apparatus will find particular advantage in high speed processing of documents, that is, in excess of 600 documents per minute.

In accordance with a second aspect of the present invention we also provide a method of analysing a security document containing a security thread in a security thread region, the method comprising illuminating the security thread region of the document with x-rays from an x-ray source, receiving x-rays from the security thread region at an x-ray detector adapted to generate a corresponding detector response, and analysing the detector response so as to generate an output signal indicative of the structure of a security thread present within the region.

The method therefore is preferably performed by the functioning, during use, of the apparatus according to the first aspect.

It will be understood that preferably the document is moved along a transport path and the document is in motion whilst the x-rays are received. Indeed it is preferred that each of the steps is performed, including the analysis, whilst the document is in motion.

The data representative of the detector response are preferably processed so as to modify the intensity contrast as part of the analysis. The data may also be processed so as to reduce noise. Each of these processing steps aids the correct analysis of the data. In simple cases the analysis may comprise comparing the detector response with a threshold intensity level, or indeed an intensity range and processing the document accordingly. Preferably however, the analysis comprises comparing the detector response with one or more master patterns corresponding to expected document types.

The output signal may take the form of a data flag or a control signal for use by other apparatus. In general the signal is at least of a binary format, being indicative of whether the document is of an expected type or an unexpected type. The signal may comprise a number of different possible values or categories, such as a number of different expected and/or unexpected document types, dependent upon the analysis performed. In most cases, the output signal is used to control the further processing of the documents downstream. Thus the method may further comprise diverting documents of an expected type along a first transport path and those of an unexpected type along a second document path. The documents may then be provided to appropriate output trays or to other apparatus for further processing.

### BRIEF DESCRIPTION OF THE DRAWINGS

Some examples of an apparatus and method according to the present invention will now be described with reference to the accompanying drawings, in which:—

FIG. 1 is schematic representation of an example apparatus;

FIG. 2 shows a short edge feed arrangement for use with the example;

FIG. 3 shows an alternative long edge feed arrangement;

FIG. 4 shows a magnetic encoded thread in more detail;

FIG. 5a is an example of optical image of a 50 Euro banknote containing an embedded magnetic coded thread;

FIG. 5b shows a similar region using an x-ray transmissive image; and,

FIG. 6 is a flow diagram of an example method.

### DETAILED DESCRIPTION OF EMBODIMENTS

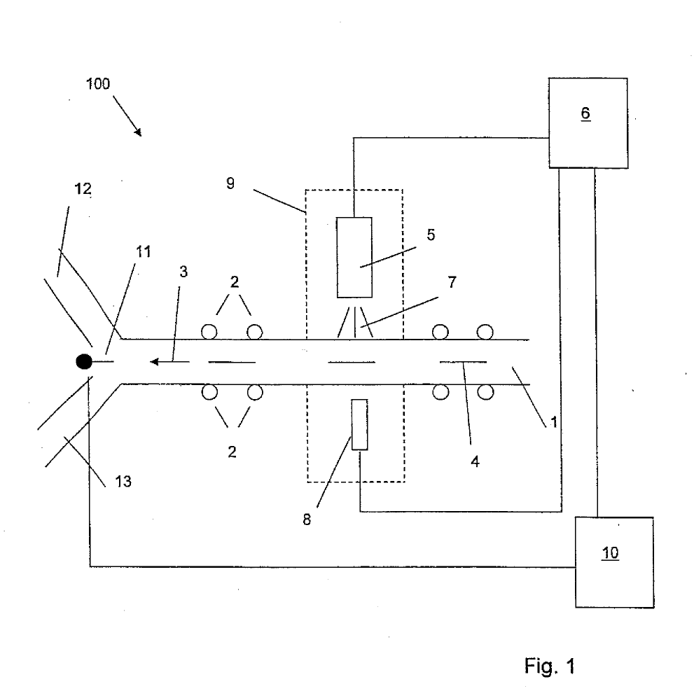

We now describe some examples of document processing apparatus in which the apparatus is adapted for processing documents in the form of banknotes. In FIG. 1, a first example is shown with the apparatus generally indicated at 100. A document transport path is illustrated at 1, this comprising a number of driven and idler rollers indicated at 2 (the drive mechanism not being shown). The rollers 2, together with various guide members and belts, securely drives banknotes along the transport path in a direction indicated by the arrow 3.

Three example banknotes 4 are shown within the transport path. As will be appreciated, FIG. 1 is schematic and therefore the separation between the opposing sides of the transport path (upper and lower in FIG. 1) is present only for clarity in illustrating the operation of the apparatus 100.

An x-ray source 5 is shown positioned within close proximity of the transport path and arranged to have an emission axis approximately normal to the surface of the banknotes 4. A typical separation between the surface of the banknote and the x-ray source 5 is a few centimetres in this example. The x-ray source has a typical operational voltage of few tens of kilovolts, in this case 40 kV. Typical operational currents lie within the range of a few tens of milliamperes, for example 14 mA.

The operation of the x-ray source is governed by a control system 6, this allowing control over the x-ray source voltage and current. Thus the intensity of x-rays emitted from the x-ray source is controllable by the controller 6. In the present example, when in use, the x-ray source emits a beam of x-rays which impinge upon the surface of the banknotes 4. This may be constrained by the use of an aperture, for example to illuminate only part of the target banknote.

An x-ray detector 6 is located upon the opposite side of the transport path 1 from the source 5. The detector is positioned so as to receive x-rays from the banknote 4 which have either passed through the banknote 4 from the source 5 or have been generated by interaction between the x-rays 7 with the material within the banknote 4 causing emission of x-rays from the material (fluorescence). The detector 8 takes the form of a line scan camera. The detector 8 extends in a direction normal to the plane of FIG. 1, this including the full width of the banknotes 4 within the transport path in the present example. A typical spatial resolution for such a camera is around 0.2 mm.

The detector 8 receives x-rays from the banknote 4 across the width of the transport path and converts the received x-rays into corresponding data which are provided to the controller 6. It should be noted that the x-ray source 5 and x-ray detector 8 are illustrated very schematically within FIG. 1, for example the figure not showing ancillary devices such as power sources for these components.

The apparatus complies with x-ray safety standards due to the use of an appropriately compliant x-ray source and due to the presence of a shielding system illustrated at 9. The shielding system comprises an x-ray absorptive enclosure constructed from a metallic material such as lead. A narrow slot within opposing walls of the shielding system 9 provides access for the transport path 1 passing through the shielding system 9.

The transport path 1 illustrated in FIG. 1 is intended to represent generically a number of possible transport path systems. Once example system provides a banknote transfer rate in excess of 1 metre per second. In some cases, a speed of around 10 metres per second may be achieved.

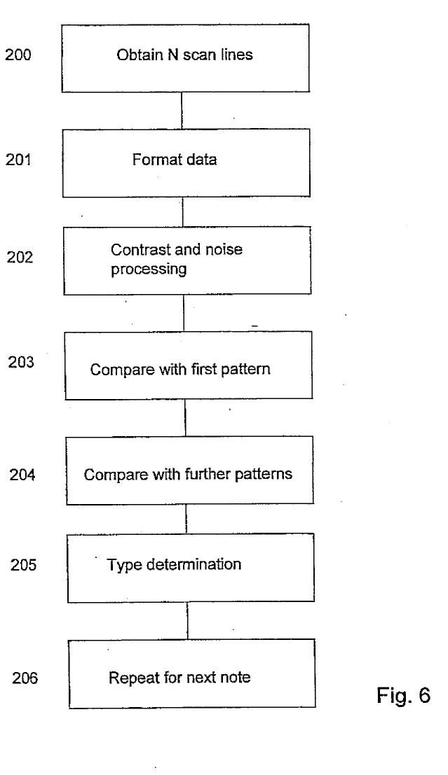

The controller 6 is operated by a computer system 10. The computer 10 uses the data received from the detector to determine whether the banknote 4 is of an “expected” type or an “unexpected” type. This is described later with reference to FIG. 6. Having determined the type of banknote using the data provided by the detector 8, the computer 10 controls the operation of a gate 11 positioned downstream of the detector 8. The gate 11 causes the banknotes to be deflected down one of two possible paths, a first path 12 being for the expected documents and the second path 13 for the unexpected documents.

“Expected” documents may be categorised depending upon the type of apparatus used, such as genuine banknotes, and in such a case unexpected documents may be banknotes which have failed to meet an authentication test based upon the data from the x-ray detector. It will also be appreciated that the gate 11 may represent a system which can divert banknotes along more than two paths, for example to separate the banknotes in terms of their denomination in addition to reject notes which are of an unexpected type, such as counterfeit notes. It will further be appreciated that the computer system 10 may receive information not only from the x-ray detector 8, but also from other detectors positioned along the transport path that are known in the art, these including visible, infrared or ultraviolet detectors in either or each of reflective or transmissive arrangements, together with various dimensional sensors including multiple thickness sensors.

The apparatus 100 is arranged to operate by analysing the security threads of banknotes passing along the transport path 1. As is known, such security threads are present in a number of different denominations of currency from a number of different countries and are typically provided as threads passing perpendicular to the long edges of the banknotes.

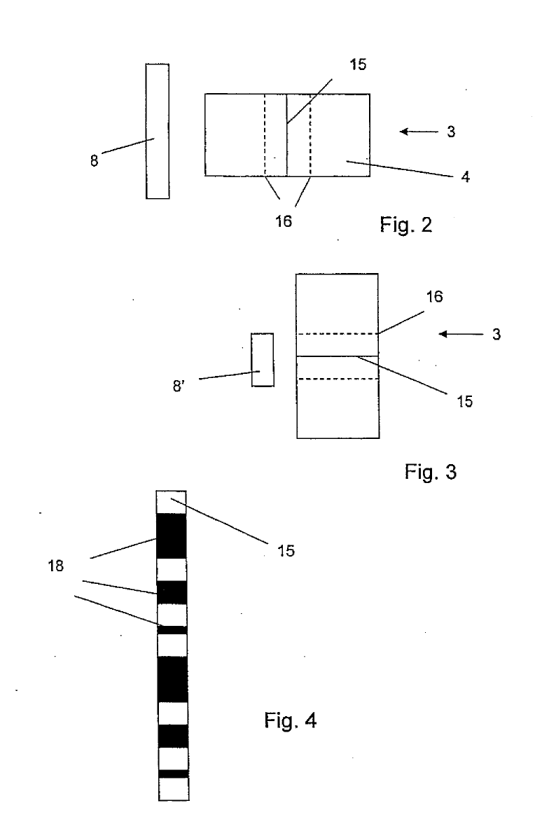

One arrangement of the apparatus of FIG. 1 is shown in FIG. 2, in which the transport mechanism is arranged as a “short edge feed” mechanism in which the short edges of the banknote are the leading and trailing edges as the banknote passes along the transport 1. This is illustrated by the arrow 3. The security thread 15 in this case has an elongate dimension substantially normal to the direction of transport. For this reason, the detector 8 is arranged as a line scan camera in which the “line” is the dimension parallel to that of the thread and spanning the banknote. Thus, as the banknote passes adjacent to the detector 8, x-ray information is received from an area spanning its width. Since in many cases the longitudinal position of the thread 15 within the banknote 4 is known to lie within a certain range, the detector 8 may only be “read out” as a region of relatively narrow dimension passes adjacent the detector. This can therefore be thought of as a security thread region 16.

Typically the area of the banknote from which x-rays are received by the detector 8 is significantly narrower in a direction 3 than the dimension of the region 16, and indeed is narrower than the width of the thread 15 along a similar dimension. Thus when in use, the controller 6 repeatedly reads out data from the detector so as to build up a series of consecutive line scans of the note and these data are then processed by the computer 10. Preferably the regions from which the x-rays are detected upon the banknote are adjacent one another such that their edges interface, although it will be appreciated that this is not essential provided sufficient x-ray data is obtained from the thread 15 in one or more of the read out areas of the note. An overlap of the regions or spaces between the regions is therefore contemplated.

An alternative feed arrangement is shown in FIG. 3 in which the banknote is conveyed in a “long edge” feed configuration, the long edge therefore forming the leading and trailing edges of the note as it passes along the transport path 1. As will be appreciated in this case, the extent of the detector 8′ need only be that of the region 16 in which the thread 15 may be positioned. Thus a smaller detector of shorter elongation may be used.

As discussed earlier, it is known in the art to provide security threads 15 with magnetically encoded information, this being provided by the use of magnetic material spaced at various positions along the thread. This is illustrated in FIG. 4 where the magnetic material 18 is illustrated. The length and position of each material deposit is significant, with the length typically comprising multiples of a base unit length. This is typically provided as a repeating code along the long dimension of the thread. The banknotes may therefore contain two or more repeats of the coded information along the thread. Conventionally, the magnetic coded information is detected by a magnetic detection device within the apparatus. The magnetic material in question may be either permanently or temporarily magnetised, the magnetisation sometimes being provided earlier in the transport path in the case of temporary magnetisation. Typically iron based materials are used for this purpose.

The present invention realises that magnetic material such as that illustrated at 18 of FIG. 4 has significantly different x-ray interaction properties than the substrate material of the thread 15, for example the substrate material may be formed from one or more of a plastics material or a low atomic number metal element such as aluminium.

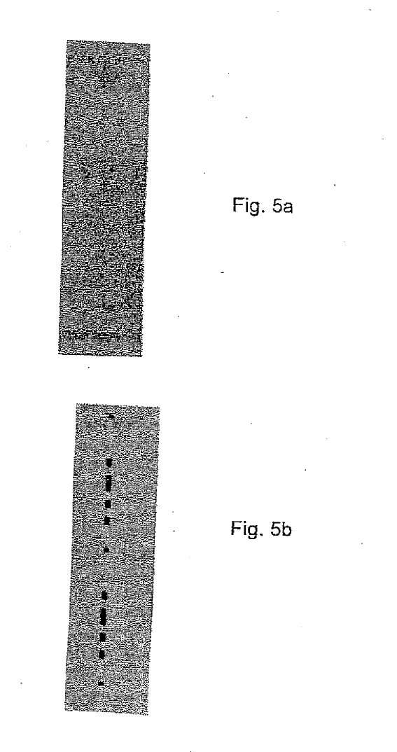

To illustrate the x-ray image contrast provided by magnetic materials already used within banknotes, reference is now made to FIGS. 5a and 5b. FIG. 5a is an optical image of a security thread region of a 50 Euro banknote containing an embedded security thread. FIG. 5b shows the same region upon the same banknote. The thread is all but invisible in the optical image of FIG. 5a but is clearly visible in FIG. 5b. Notably it is primarily the magnetic material that provides the contrast in this particular image, this being significantly in excess of that provided by the thread substrate material. As can be seen in FIG. 5b, a two times repeat of the magnetic code is clearly visible as very high contrast. Thus it will be appreciated that the magnetic code represented by the positions of the magnetic material can be rapidly and easily read from an x-ray image.

Turning now to the use of the data generated by the x-ray detector 8, there are a number of ways in which the information may be processed, depending upon the intended use of the apparatus 100.

In very a basic example, line scan data from the detector 8 can be analysed by monitoring the number of “pixels” from the x-ray detector which provide a transmissive intensity level below a predetermined threshold (data corresponding to “dark” pixels). Thus, regardless of the positional information, if more than a predetermined number of pixels meet the threshold requirement, or the number of pixels meeting such a requirement lies within a predetermined range, then a magnetic code can be deemed to be present. With this simple level of analysis, the banknote in question can be deemed to be of an “expected” type and is therefore directed, via gate 11, along the transport path branch 12. Any banknotes not meeting this criterion are diverted along the “unexpected” path 13 as controlled by the computer 10. Such a test only provides a very basic test for the provision of magnetic codes within the thread and no spatial information regarding the position of the material within the thread is used in this case.

In a more advanced and preferred alternative, data representing consecutive scan lines from the detector 8 are formed into image data, this for example being represented by the image illustrated in FIG. 5b. The data are then analysed by image analysis techniques analogous to those used in optical imaging of banknotes. This is now discussed in more detail with reference to FIG. 6 which is a flow diagram of such a method.

In FIG. 6, at step 200, the x-ray source 5 and detector 8 are controlled by the controller in response to instruction from the computer 10 so as to produce an optimised level of contrast for a given transport path speed and type of banknote. For a given banknote passing along the transport path 1 between the source 5 and detector 8, N lines of scan data are obtained via the controller 6 from the x-ray detector 8.

As will be appreciated, each scan line contains a large quantity of “pixel” data, including an x-ray intensity for each pixel along the line of the detector. At step 201, the scan lines are arranged in a predetermined format for processing. This may include arranging the data in a store in which the pixels on different scan lines are represented consecutively in a data stream.

At step 202, the data are processed according to contrast criteria to ensure that the expected contrast levels for such data have been received. Some processing analogous to “gamma correction” may be performed depending upon the known intensity response of the detector. This step may also involve further processing steps to reduce noise within the data.

At step 203, a first “master” image or pattern is obtained from a store within the computer 10, and the data are compared with the master pattern data. The data of the master and that obtained from the detector correspond to similar regions of the banknote, specifically the security thread region 16 in this example. The master represents nominal image data from a genuine banknote in a given orientation. The master may be generated by using the apparatus to scan numerous genuine banknotes.

At step 204, similar comparisons are made with two or more other master patterns. Typically four master patterns are provided for each type of banknote, these relating to the four different possible ways that a banknote may be fed in a short edge feed or long edge feed mode.

At step 205, a “type” determination is made based upon the comparison steps 203 and 204. Specifically, if one of the master patterns matches the data corresponding to that received by the detector to a sufficient predetermined degree of accuracy then a corresponding output signal is generated, and used to control the gate 11 to direct the note along the “expected” transport path branch. If an insufficient match is obtained with each of the master patterns, then the note is determined as an unexpected type and is sent along the path branch 13.

At step 206, the process returns to step 200 so as to analyse the next note in the transport path. The computer 10 may make adjustments to the operational parameters of the source and detector (such as power or gain) or the speed of the transport path at each step 200 so as to maximise the accuracy of the analysis. Such adjustments may be made based upon the data received from one or more banknotes analysed in previous steps.

It will further be appreciated that different denominations of note may be distinguished using the method of FIG. 6 since these typically have different magnetic codes. Of course, security documents can be manufactured, having bespoke codes for use with the present invention. A great advantage is however derived from the backwards compatibility of the invention with coded magnetic threads already in circulation.

Whilst four patterns may be used for each type of denomination, if there are five different denomination types for a particular currency, then 20 different patterns may be used for comparison, provided at least each denomination has a different code. If the apparatus is arranged to distinguish between two or more different types of denomination within the “expected” types, together with unexpected types, then either a multiple path gate 11 may be used, or the path 12 may be subdivided into further paths downstream using one or more further gates.

It should be noted that the repeat of the magnetic code, such as the two times repeat illustrated in FIG. 5b, may be used to improve the accuracy of the type determination since this effectively acts as a second source of the code. Furthermore, in step 202, following the contrast and noise processing, it may be quickly determined that a note of unexpected types is present since the expected contrast or intensity range within the data may not be present. This note may therefore be rejected as an unexpected type at step 202. Of course this may be due to the note being counterfeit or, in the case of a genuine note being present, it may indicate a malfunction with the detector or the source.

With the method illustrated in FIG. 6, it will be appreciated that a short edge feed or a long edge feed may be used.

The apparatus discussed above may be used in various different types of different document processing systems. For example, it may be used in systems to distinguish between types of document, when determining different denominations of document, or in an authentication system. It will be appreciated that the system may be used in conjunction with other detection techniques, including optical, ultraviolet, infrared, magnetic and dimensional techniques so as to improve the accuracy of document processing by inspecting either similar or dissimilar features to those inspected using x-rays.

What is claimed is:

1. Apparatus for analysing a security document containing a security thread in a security thread region, comprising:
an x-ray source configured to illuminate the security document in the security thread region;
an x-ray detector configured to receive x-rays from the security thread region of the document and to generate a corresponding detector response;
a processor configured to form the detector response into image data, to analyse the image data and to generate an output signal indicative of the structure of a security thread present within the region; and
a transport path along which the document is passed so as to provide it for illumination by the x-ray source, wherein the x-ray detector is a line scan detector.

2. Apparatus according to claim 1, wherein the security document is fed along the transport path by a leading edge and wherein the length of the detector is equal to at least that of the leading edge.

3. Apparatus according to claim 1, wherein a line defining the thread length is arranged approximately normal to a line defining the length of the detector.

4. Apparatus according to claim 1, wherein the x-ray source and x-ray detector are located upon opposite sides of the transport path according to a transmissive arrangement.

5. Apparatus according to claim 1, wherein the x-ray source and/or detector are positioned approximately normally to the face of the document as it passes along the transport path.

6. Apparatus according to claim 1, wherein the thread is a security thread containing one or more regions of magnetic or magnetisable material and wherein the apparatus is adapted to locate the position of the said one or more regions of the said material.

7. Apparatus according to claim 6, wherein the x-ray source and detector are adapted to generate sufficient x-ray contrast so as to locate the position of the said one or more regions.

8. Apparatus according to claim 1, wherein the processor is adapted to analyse the detector response by comparing the obtained response with a predetermined response.

9. Apparatus according to claim 8, wherein the processor is adapted to generate an image of the security thread region formed from a number of detector responses generated at different locations for each document.

10. Apparatus according to claim 8, wherein the processor is adapted to compare the image with one or more predetermined master images.

11. Apparatus according to claim 10, wherein the comparison comprises using an image analysis process and wherein the output signal is dependent upon the result of the image analysis process.

12. Apparatus according to claim 8, wherein the output signal is dependent upon the degree of correspondence between the obtained and predetermined responses.

13. A method of analysing a security document containing a security thread in a security thread region, the method comprising:
illuminating the security thread region of the document with x-rays from an x-ray source, by passing the security document along a transport path;
receiving x-rays from the security thread region at an x-ray detector adapted to generate a corresponding detector response; and
analysing the detector response by forming the detector response into image data, analysing the image data, and generating an output image indicative of the structure of a security thread present within the region, wherein
the x-ray detector is a line scan detector.

14. A method according to claim 13 wherein the document is in motion whilst the x-rays are received.

15. A method according to claim 13 further comprising processing data representative of the detector response so as to modify an intensity contrast. response with one or more master patterns corresponding to expected document types.

16. A method according to claim 13, wherein the output signal is indicative of whether the document is of an expected type or an unexpected type.

17. A method according to claim 16, further comprising diverting documents of an expected type along a first transport path and those of an unexpected type along a second document path.

18. A method for processing a document containing a security thread in a security thread region, the method comprising:
illuminating the security thread region of the document with x-rays from an x-ray source;
receiving x-rays from the security thread region at an x-ray detector adapted to generate a corresponding detector response as data;
processing the data to reduce noise thereby creating noise-reduced data;
processing the noise-reduced data according to one or more contrast criteria thereby creating contrast-enhanced, noise-reduced data;
comparing the contrast-enhanced, noise-reduced data to a pre-determined master pattern data; and
determining how to further process the document based on the comparison step.

19. The method of claim 18 wherein the comparison step comprises deeming a document as an authentic document if the contrast-enhanced, noise-reduced data and the master pattern data are substantially similar and deeming a document unexpected if the contrast-enhanced, noise-reduced data and the master pattern data are not substantially similar.

20. The method of claim 19 further comprising directing the document along a first path if the document is deemed an authentic document; and directing the document along a second path if the document is deemed unexpected.
